(19) United States
(12) Patent Application Publication
(10) Pub. No.: US 2004/0203432 A1
(43) Pub. Date: Oct. 14, 2004

(54) Communication system

(76) Inventors: Basavaraj Patil, Coppell, TX (US); Sreenivas Addagatla, Irving, TX (US); Timothy L. Moran, Argyle, TX (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/256,019

(22) Filed: Sep. 27, 2002

(51) Int. Cl. H04B 17/00; H04M 1/66; H04M 1/68; H04M 3/16

(52) U.S. Cl. 455/67.11; 455/410; 455/411

(57) ABSTRACT

A status information system for use in a communications network. The status information system comprises information management means through which a first entity operable in the network can request to receive status information about one or more specified other entities of the network and which means is arranged to obtain the said status information. The system further comprises delivery means through which the first entity can receive status information about other entities of the network. The delivery means is arranged: (i) to receive status information about entities of the network including to receive from the information management means the said status information about the specified one or more entities, and (ii) to authenticate the received status information. The delivery means is further arranged, on the basis of the authentication, (a) to send received status information to the first entity when the status information is authenticated as being about the specified one or more entities, and (b) to not send received status information to the first entity when the status information is not authenticated as being about the specified one or more entities.

### FIELD OF THE INVENTION

The present invention relates to a status information system for use in a communications network through which an entity can receive status information about other specified entities of the network, and a method for an entity of a communications network to receive status information about other specified entities of the network. Such a system or method can allow information about only specified entities to be sent to the entity.

### BACKGROUND OF THE INVENTION

It is known to provide a wireless telecommunications network across which two users of mobile equipment can communicate, or a mobile user can communicate with a fixed location user by transfer of a signal from the wireless network to a land line. One known type of wireless communications network is the 3^{rd} Generation Partnership Projects (3GPP) system which is currently being brought into use around the world. This network is known as the Universal Mobile Telecommunications System (UMTS) and one advantage that it has over previous wireless network standards is that it allows far faster rates of data transfer using a packet-switched (core) network (PS-CN) in addition to voice transfer over a circuit-switched (core) network (CS-CN). The PS-CN can connect to the Internet and the CS-CN can connect to the Public Switched Telephony Network (PSTN) and the Integrated Digital Services Network (ISDN).

In practice, the CS-CN functionality is achieved via a subsystem called the IP Multimedia Subsystem (IMS) in the PS-CN. The IMS can connect to an IP based network such as the Internet to provide services such as Voice over IP. The signalling protocol used between user equipment (UE) such as mobile telephones and the IMS and between components of the IMS is the Session Initiation Protocol (SIP). This protocol has user registration (e.g. location and communication capability), addressing and routing capabilities.

One important set of components within an IMS network is the Call Session Control Functions (CSCF). These perform a server service in that they process signals and control a wireless user's session, as well as performing an address translation function and handling of subscriber profiles. If a user is in the home network, the network is accessed via the Serving-CSCF (S-CSCF), and this server provides session control and other services for the user. If the user is roaming, the local network in the roaming location is accessed via a Proxy-CSCF (P-CSCF) which provides local control and services for the user as well as being in contact with the user's S-CSCF. The S-CSCF and if necessary the P-CSCF also perform a billing function.

One type of service that can be provided by a 3G network is a Presence service. The idea of this service is to enable users to obtain status information about other users. A user who wishes information on his status to be available to others is termed a presentity. A user who wishes to obtain information on the status of a presentity is termed a Presence client or subscriber. Both a presentity and a subscriber may be a mobile telephone but one or both could be other UE such as a pager or PDA. The status information can mean various things in practice, such as the presentity's physical location, call state (e.g. busy, able to accept communications), willingness to accept communications (e.g. available to certain or all clients, in a meeting) and what communication medium would be preferred (e.g. voice, e-mail). The presentity uses an agent through which it registers a request to have its status information available. The subscriber requests to receive status information about one or more presentities through the P-CSCF, and the P-CSCF passes the information to the prescence server which is responsible for maintaining the status of the presentity that the subscriber is subscribing to. When the presentity changes its status, the server informs the subscriber via the P-CSCF.

A problem that arises with this system is that the subscriber is vulnerable to spam messages. This is because a malicious node wishing to send a spam message to the subscriber can easily do so by tapping into the IMS and reading the destination address of status information messages. In other words, the destination address is the subscriber's UE address and the malicious node can simply send his own status information message to the P-CSCF bearing the subscriber's UE address. This message will then be forwarded to the subscriber. Thus the malicious node is able to inform the subscriber of the status of, for example, a commercial user in the hope that the subscriber will then take an interest and subscribe to the commercial user. This is a nuisance for the subscriber who may be bombarded with unwanted messages.

Another problem that can arise with this system is that a malicious node can send NOTIFY messages perpetually on behalf of a third party by spoofing the “from” field in the SIP header. If NOTIFY messages are sent frequently they are delivered to the user over the air interface. Usage of the air interface for delivering data is charged. This is a significant irritation to the user because services to which the user has not subscribed nor requested to be notified of must nevertheless be paid for.

It would be desirable to provide a telecommunications network in which the problem of interference by malicious nodes is mitigated.

### SUMMARY OF THE INVENTION

According to a first aspect of the present invention, there is provided a status information system for use in a communications network, the status information system comprising: information management means through which a first entity operable in the network can request to receive status information about one or more specified other entities of the network and which means is arranged to obtain the said status information; and delivery means through which the first entity can receive status information about other entities of the network, the delivery means being arranged:

(i) to receive status information about entities of the network including to receive from the information management means the said status information about the specified one or more entities; and

(ii) to authenticate the received status information and on the basis of the authentication:

(a) to send received status information to the first entity when the status information is authenticated as being about the specified one or more entities; and

(b) to not send received status information to the first entity when the status information is not authenticated as being about the specified one or more entities.

According to a second aspect of the present invention, there is provided a status information system for use in a communications network, the status information system comprising : information management means through which a first entity can request to receive status information about one or more specified other entities of the network and which means is arranged to obtain the said status information; and delivery means through which the first entity can receive status information about other entities of the network, the information management means and the delivery means being arranged:

(i) to receive status information about entities of the network including to receive from the information management means the said status information about the specified one or more entities;

(ii) to send received status information about the specified one or more entities to the first entity; and

(iii) to not send status information about entities other than the specified other entities to the first entity.

According to a third aspect of the present invention, there is provided a method for a first entity of a communications network to receive status information about one or more specified other entities of the network, the method comprising the steps of: receiving a request from the first entity to receive status information about one or more specified other entities of the network; receiving status information about other entities of the network; and authenticating the received status information and on the basis of the authentication:

(a) sending the received status information to the first entity when the status information is authenticated as being about the specified one or more entities; and

(b) not sending the received status information to the first entity about other network entities when the status information is not authenticated as being about the specified one or more entities.

By entity is meant any equipment or part of equipment operable in a communications network, for example a terminal, a terminal operable by a user having a subscriber identity, or an application running on a terminal.

### BRIEF DESCRIPTION OF THE DRAWINGS

The invention will now be described, by way of example only, with reference to the accompanying drawings in which:

FIG. 1 shows part of a telecommunications network and some users of the network

FIG. 2 is a signalling diagram

### DESCRIPTION OF THE PREFERRED EMBODIMENTS

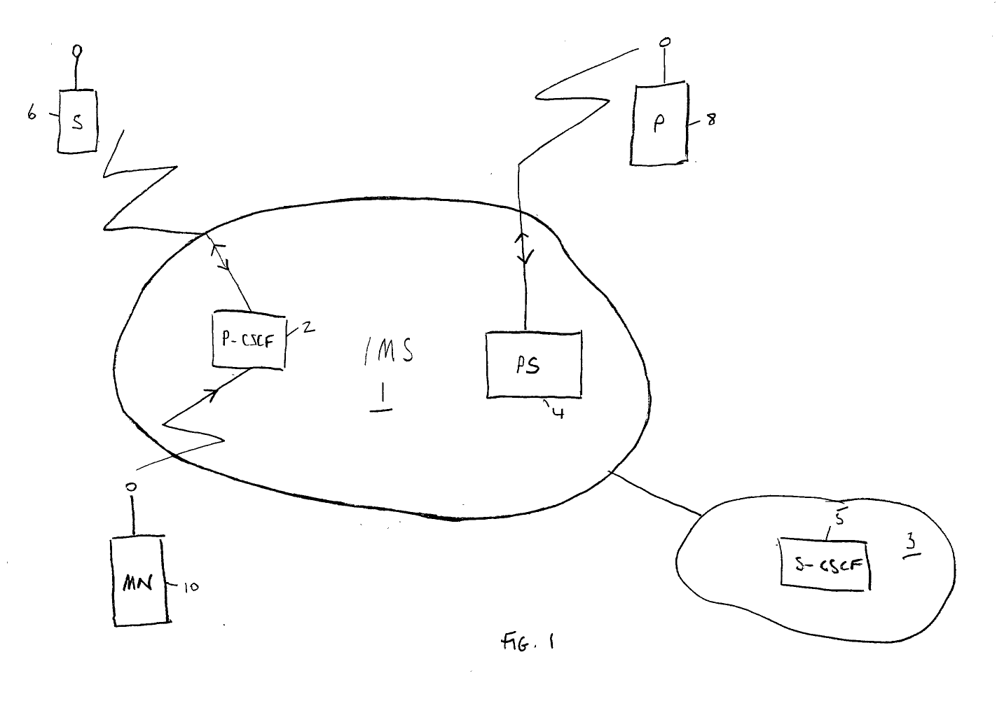

FIG. 1 shows the components of a 3G network that are relevant to the embodiment of the invention. The central area is the IMS network 1. Within the IMS network 1 is a P-CSCF 2 and a presence server (PS) 4. In practice there would be more than one P-CSCF and presence server within an IMS network. However the PS 4 may be a part of the IMS network or it may not be a part of the IMS network (a third party PS). The PS 4 maintains the status of a number of presentities.

A second IMS network 3 is shown adjacent to the IMS network 1. In practice this network would not necessarily be adjacent to the IMS network 1. The network 3 contains the S-CSCF 5 for the subscriber 6. Since the subscriber 6 is closer to the IMS network 1 than the IMS network 3, services are provided to the subscriber 6 via the P-CSCF 2.

Outside the network 1 are shown three user entities. A user 6 labelled S is a subscriber to the presence service. The subscriber 6's UE is a mobile telephone and the figure shows that signals are exchanged between the subscriber 6 and the P-CSCF 2. In practice other components would exchange signals with the subscriber 6, for example a Serving GPRS Support Node (SGSN). The subscriber 6 is in communication with the P-CSCF, which in turn communicates with the appropriate S-CSCF for the subscriber.

A user 8 labelled P is a presentity. The presentity 8 exchanges signals with the PS 4, as will be described below.

Finally, a user 10 labelled MN is a malicious node. The malicious node 10 sends signals to the P-CSCF 2 for passing onto the subscriber 6.

Upon arrival in the coverage area of the IMS 1, the first step is for the subscriber 6 to register with the P-CSCF. This will enable the subscriber 6 to be provided with all the necessary local services and will provide the P-CSCF with details of the subscriber 6's S-CSCF.

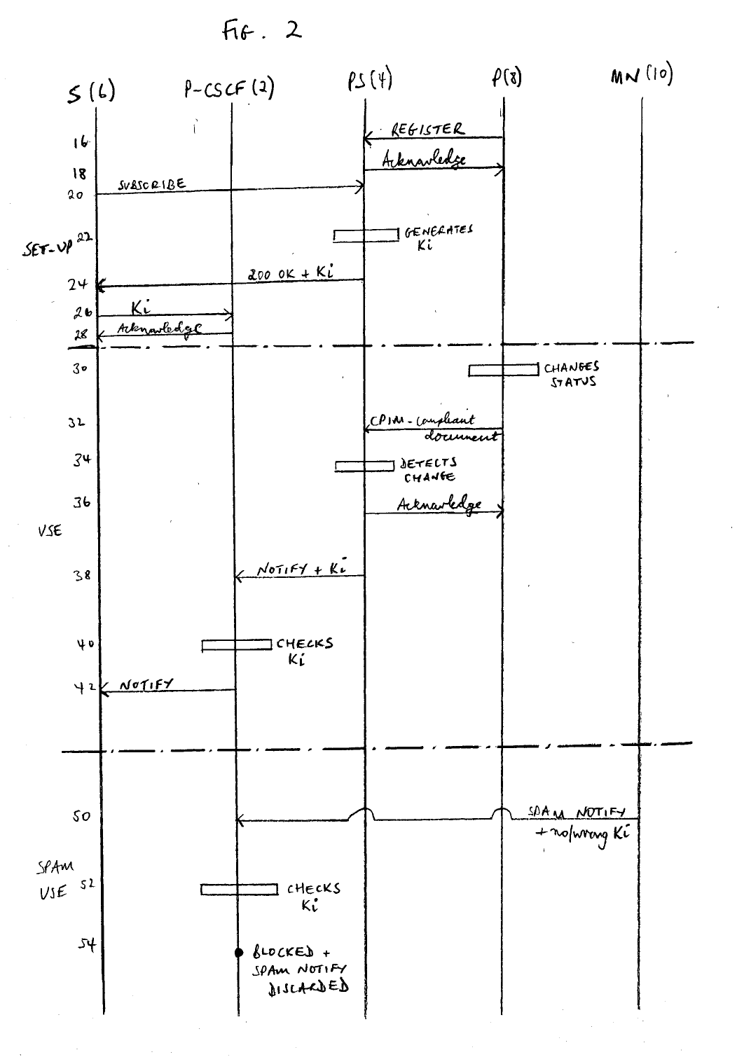

Turning now to FIG. 2, signalling in accordance with the embodiment is shown schematically. FIG. 2 assumes that the subscriber 6 has registered via the P-CSCF. The five entities, the subscriber 6, the P-CSCF 2, the PS 4, the presentity 8 and the malicious node 10 are shown across the top of the figure. Signals are shown as arrows and actions as boxes, each signal/action being numbered. The diagram is divided into three sections—set-up, use and spam use.

The set-up procedure will be described first.

16, 18 The presentity 8 registers its desire to be a presentity with the PS 4. This is done by means of a SIP REGISTER signal and is acknowledged by the PS 4 with a SIP acknowledgement signal such as a 200 OK signal. The REGISTER signal can indicate various statuses of the presentity 8 such as “in the office and available for calls”, “at home and available for private calls only” and “busy”. The indicated status may of course not be the true status but is the status that the presentity wishes other users to see. The status could be even more specific, for example by specifying only the user addresses from which it is willing to accept communications and by which type of medium. For example, in a meeting the presentity 8 may only wish to receive e-mails and not voice calls.

Each time the status of the presentity 8 changes, for example if the presentity arrives in the office having been home, the presentity will inform the PS 4 of its changed status. Thus the PS 4 receives regular updates on the status of the presentity 8. The effect of a change in status will be described below.

20 The first signal is the subscriber 6 sending a SUBSCRIBE signal to the PS 4. This signal is sent via the P-CSCF 2 but is forwarded to the PS 4. The SUBSCRIBE signal asks the PS 4 for the subscriber 6 to be informed each time the status of the presentity 8 changes. The SUBSCRIBE signal contains an indication that the subscriber 6 only wishes to receive notifications of the change in status of that presentity, or, alternatively, the subscriber 6 has previously informed the P-CSCF 2 of this and the P-CSCF 2 informs the PS 4 that security measures must be taken.

22 Upon receiving the SUBSCRIBE signal and information that security measures are required the PS 4 generates a key Ki. This and the authentication algorithm to be used are selected so that the scheme is difficult for third parties to crack.

24 The PS 4 transfers the Ki to the subscriber 6 over a secure channel as part of a SIP 200 OK signal.

26 The subscriber 6 sends the Ki to the P-CSCF 2 over a secure channel. This value is stored for future use. In order for the subsequent procedure to work correctly, the subscriber 6 must also inform the P-CSCF 2 of the purpose of this key.

28 The P-CSCF 2 acknowledges receipt of the Ki. The use procedure will now be described.

30 From time to time the presentity 8 changes its status, for example it may decide that it has become available to receive calls.

32 When the presentity 8 changes status, a Common Profile for Instant Messaging (CPIM)-compliant document is uploaded to the PS 4. Such a document is in a format compatitble with Prescence information.

34 Thus the PS 4 detects the change in status of the presentity 8.

36 The PS 4 acknowledges receipt of the document.

38 The PS 4 knows that the subscriber 6 has subscribed to be informed of changes in the status of the presentity 8 so it sends a NOTIFY signal to the subscriber 6. This NOTIFY signal includes an authentication portion formed using the Ki that was assigned by the PS 4 to the subscriber 6. The authentication portion could be an HMAC-MD5 digest, or other forms of authentication could be used.

40 The NOTIFY signal arrives at the P-CSCF 2, which verifies the authentication portion using the same authentication function and the key Ki, which it has stored (in step 26). The P-CSCF 2 is then able to compare the calculated authentication portion to the received authentication portion.

42 In this case the P-CSCF 2 finds that the two authentication portions match and it therefore forwards the NOTIFY message onto the subscriber 6.

Thus the subscriber 6 is informed of the change in status of the presentity 8. The process is repeated each time the presentity changes status.

A spam use procedure will now be described.

As explained before, a malicious node 10 can obtain the user address of the subscriber 6 because this information is contained in the header of packet signals sent across the IMS network 1 to the subscriber 6.

50 If a malicious node 10 wants to send a NOTIFY message to the subscriber 6 it will send this message to the P-CSCF 2 hoping that the P-CSCF 2 will forward it to the subscriber 6.

52 However, the P-CSCF 2 is expecting the authentication portion formed using the key Ki, which is not known to the malicious node. It is thus possible that the spam NOTIFY will contain no authentication portion in the packet body. Alternatively the malicious node might guess the authentication portion, but due to the authentication algorithm selected, and the fact that the malicious node does not know the key Ki, this is very unlikely to be correct.

54 In either case, when the P-CSCF 2 verifies the authentication portion it will find it to be incorrect. Therefore the P-CSCF 2 blocks the spam NOTIFY message.

Thus, in the case of either form of spam NOTIFY the P-CSCF 2 will block the signal and will not forward it onto the subscriber 6 because it has determined that the authentication portion is not formed according to the correct key Ki and that therefore the subscriber 6 does not wish to receive the message.

Alternatively, if the malicious node sends its NOTIFY message to the PS 4, the PS 4 will not attempt to forward it to the subscriber 6 because it will know that the NOTIFY message has not come from a presentity that the subscriber 6 is interested in.

Thus the embodiment provides a way of preventing the subscriber 6 from receiving unwanted spam NOTIFY messages. This is an improvement over prior art systems which do not have any means of filtering NOTIFY messages.

In an alternative embodiment of the set-up procedure the key Ki could be generated by the subscriber 6 instead of by the PS 8. In this case the subscriber 6 would send the key, preferably over a secure channel, together with the SUBSCRIBE signal to the PS 8 and to the P-CSCF 2. Having received the key, the PS 8 and the P-CSCF 2 can use it to verify the authenticity of NOTIFY messages, as described above.

It can be appreciated that a subscriber can subscribe to a number of different presentities. The above-described process would be required for every subscription. A subscriber could use different keys for different presentities or alternatively each subscriber could have a key for use with all presentities to which he or she subscribes. Different subscribers could each use different keys for a given presentity or alternatively the same key could be used by all subscribers to a presentity.

It will be understood by those skilled in the art that although the network forming the basis of the embodiment is 3G, the described procedure could be applied to other types of networks using different network entities. The S-CSCF could be used instead of the P-CSCF to filter spam NOTIFY messages. Also, means other than a key could be used to enable the P-CSCF to filter NOTIFY messages.

1. A status information system for use in a communications network, the status information system comprising:
information management means through which a first entity operable in the network can request to receive status information about one or more specified other entities of the network and which means is arranged to obtain the said status information; and
delivery means through which the first entity can receive status information about other entities of the network, the delivery means being arranged:
(i) to receive status information about entities of the network including to receive from the information management means the said status information about the specified one or more entities; and
(ii) to authenticate the received status information and on the basis of the authentication:
(a) to send received status information to the first entity when the status information is authenticated as being about the specified one or more entities; and
(b) to not send received status information to the first entity when the status information is not authenticated as being about the specified one or more entities.

2. A system according to claim 1, wherein the said status information about the specified one or more entities indicates a change in status of the one or more specified entities.

3. A system according to claim 2, wherein the information management means is arranged to receive the said status information about each specified one or more entities each time the status of that entity changes.

4. A system according to claim 3, wherein the delivery means is arranged to perform step (ii) (a) each time it receives status information about any one of the specified one or more entities, in respect of that entity.

5. A system according to any preceding claim, wherein status information received from the information management means about a specified entity includes a security means from which the delivery means can ascertain that the status information is about a specified entity.

6. A system according to claim 5, wherein status information received from other than specified network entities does not include such security means.

7. A system according to claim 5 or claim 6, wherein the security means is a key corresponding to an authentication function.

8. A system according to claim 7, wherein the first entity is arranged to generate the key and send the key to the information management means with the request to receive status information.

9. A system according to claim 7, wherein the information management means is arranged to generate the key upon receipt of the request to receive status information from the first entity, and to send the key to the first entity.

10. A system according to claim 8 or claim 9, wherein the first entity is further arranged to send the key to the delivery means.

11. A system according to claim 10, wherein the delivery means is arranged to ascertain whether received status information is from a specified entity by comparing the key received with the status information to the key received from the first entity.

12. A system according to any of claims 6 to 11, wherein the information management means is arranged to calculate an authentication portion as the authentication function of the key and part of the status information and send the result to the delivery means together with the status information.

13. A system according to claim 12, wherein the delivery means is arranged to calculate the authentication portion using the key received from the first entity and compare the result to the authentication portion received together with the status information.

14. A system according to any preceding claim, wherein the status information is Presence information.

15. A system according to claim 14, wherein the request by the first entity to receive status information about one or more specified other entities of the network is a SIP SUBSCRIBE request.

16. A system according to claim 14 or claim 15, wherein the status information received by the delivery means about entities of the network is a SIP NOTIFY message.

17. A system according to any of claims 14 to 16, wherein the information management means is a Presence Server to the one or more specified entities.

18. A system according to any of claims 14 to 17, wherein the delivery means is a Proxy-CSCF.

19. A system according to any of claims 2 to 18, wherein a change in status can mean any one or more of:
change in physical location; change in call state; change in willingness to accept communication; and preferred communication medium.

20. A status information system for use in a communications network, the status information system comprising:
information management means through which a first entity can request to receive status information about one or more specified other entities of the network and which means is arranged to obtain the said status information; and
delivery means through which the first entity can receive status information about other entities of the network,
the information management means and the delivery means being arranged:
(i) to receive status information about entities of the network including to receive from the information management means the said status information about the specified one or more entities;
(ii) to send received status information about the specified one or more entities to the first entity; and
(iii) to not send status information about entities other than the specified entities to the first entity.

21. A method for a first entity of a communications network to receive status information about one or more specified other entities of the network, the method comprising the steps of:
receiving a request from the first entity to receive status information about one or more specified other entities of the network;
receiving status information about other entities of the network; and
authenticating the received status information and on the basis of the authentication:
(a) sending the received status information to the first entity when the status information is authenticated as being about the specified one or more entities; and
(b) not sending the received status information to the first entity about other network entities when the status information is not authenticated as being about the specified one or more entities.
